(19) United States
(12) Patent Application Publication
(10) Pub. No.: US 2022/0084119 A1
(43) Pub. Date: Mar. 17, 2022

(54) METHOD, SYSTEM, AND DEVICE FOR PREDICTING STOCK PERFORMANCE AND BUILDING AN ALERT MODEL FOR SUCH ESTIMATION

(71) Applicants: Aaron French, Orlando, FL (US); Brian Rossignol, Orlando, FL (US)

(72) Inventors: Aaron French, Orlando, FL (US); Brian Rossignol, Orlando, FL (US)

(21) Appl. No.: 17/537,757

(22) Filed: Nov. 30, 2021

(51) Int. Cl. G06Q 40/04

(52) U.S. Cl. CPC G06Q 40/04

(57) ABSTRACT

The present invention provides a machine learning method for detecting a stock market pattern in operation of a data analysis device. The method includes an algorithm executing on at least one processor for receiving, in real time, time series readings of stock market data, and maintaining a history of past real-time readings in a memory zone of a plurality of memory zones. From the time series data, the system forecast financial market characteristics.

### FIELD OF THE INVENTION

This invention relates to a new and improved financial market pattern detector and alert system, method, and device.

### BACKGROUND

The financial market can generate generous returns to investors. The market has traditionally created an enormous amount of wealth for traders. In the last few decades, the financial market has taken a non-traditional turn as more individual investors enter the playing field, the main goal being profit. The market, however, fluctuates greatly and many cannot sustain the level of volatility that comes with it. There becomes a need for predicting market behavior. The present invention provides a solution to this problem.

### SUMMARY OF THE INVENTION

It is essential to the present disclosure, all embodiments are provided as illustrative and non-limiting representatives of various possible embodiments. In addition, the terms “is”, “can”, “can”, “will” and the like are herein uses as synonyms for an interchangeable with terms such as “may”, “may provide for”, and “it is contemplated that the present invention may” and so forth.

Furthermore, all elements listed by name, encompass all equivalents for such elements. Such equivalents are contemplated for each element named herein.

For purposes of summarizing, certain aspects, advantages, and novel features of the present invention are provided herein. It is to be understood that not all aspects, advantages, or novel features may be provided in any one particular embodiment. Thus, the disclosed subject matter may be embodied or carried out in a manner that achieves or optimizes one aspect, advantages, or novel features or group of features without achieving all aspects, advantages, or novel features as may be taught or suggested.

In view of the foregoing disadvantages inherent in the known art, the present invention provides a novel solution for detecting financial market patterns.

The features of the invention, which are believed to be novel, are particularly pointed out and distinctly claimed in the concluding portion of the specification. These and other features, aspects, and advantages of the present invention will become better understood with reference to the following drawings and detailed description.

In an embodiment this invention provides a machine learning method for detecting a financial market pattern in operation of a data analysis device. The method includes an algorithm executing on at least one processor for receiving, in real time, time series readings of financial market data, and maintaining a history of past real-time readings in a memory zone of a plurality of memory zones. From the time series data, the system forecasts a set of market characteristics and displays an alert on a GUI of a user device.

In a further embodiment this invention provides a machine learning system for detecting a financial market pattern in operation of a data analysis device. The method includes an algorithm executing on at least one processor for receiving, in real time, time series readings of financial market data, and maintaining a history of past real-time readings in a memory zone of a plurality of memory zones. From the time series data, the system forecasts a set of market characteristics and display an alert on a GUI of a user device.

In a further embodiment this invention provides a machine learning device for detecting a financial market pattern. The method includes an algorithm executing on at least one processor for receiving, in real time, time series readings of financial market data, and maintaining a history of past real-time readings in a memory zone of a plurality of memory zones. From the time series data, the system forecasts a set of market characteristics and display an alert on a GUI of a user device.

The embodiments of the invention described herein are exemplary and numerous modifications, variations, and rearrangements can be readily envisioned to achieve substantially equivalent results, all of which are intended to be embraced within the spirit and scope of the invention. Furthermore, while the preferred embodiment of the invention has been described in terms of the components and configurations, it is understood that the invention is not limited to those specific dimensions or configurations but is to be accorded the full breadth of the spirit of the invention.

### BRIEF DESCRIPTION OF THE DRAWINGS

These and other features, aspects and advantages of the present invention will become better understood with regard to the following description, appended claims, and accompanying figures.

FIG. 1 shows the network connections between the devices, which are capable of implementing the present embodiments.

FIG. 2 is an exemplary illustrative network environment where various embodiments of the present invention are said to function.

FIG. 3 is an exemplary illustrative user interface where various embodiments of the present invention are said to function.

FIG. 4 is an exemplary illustrative embodiment of the chart module.

FIG. 5 shows a flow chart of an exemplary financial market alert generation consistent with disclosed embodiments.

FIG. 6 shows a flow chart of an exemplary method for generating a first high valuation for a first pattern, consistent with disclosed embodiments.

FIG. 7 shows a flow chart of an exemplary method for generating a first low valuation for a first pattern, consistent with disclosed embodiments.

FIG. 8 shows a flow chart of an exemplary method for evaluating a price for validity for a first pattern, consistent with disclosed embodiments.

FIG. 9 shows a flow chart of an exemplary method for generating a second high valuation for a first pattern, consistent with disclosed embodiments.

FIG. 10 shows a flow chart of an exemplary method for generating a second low valuation for a first pattern, consistent with disclosed embodiments.

FIG. 11 shows a flow chart of an exemplary method for generating a first low valuation for a second pattern, consistent with disclosed embodiments.

FIG. 12 shows a flow chart of an exemplary method for generating a first high valuation for a second pattern, consistent with disclosed embodiments.

FIG. 13 shows a flow chart of an exemplary method for evaluating a price for validity for a second pattern, consistent with disclosed embodiments.

FIG. 14 shows a flow chart of an exemplary method for generating a second low valuation for a second pattern, consistent with disclosed embodiments.

FIG. 15 shows a flow chart of an exemplary method for generating a second high valuation for a second pattern, consistent with disclosed embodiments.

### DETAILED DESCRIPTION

The present invention overcomes the limitations of the prior art by providing a novel method, system, and device for detecting financial market patterns and generating a set of alerts.

It is essential to understand that the drawings and the associated descriptions are provided to illustrate potential embodiments of the invention and not to limit the scope of the invention. Reference in the specification to “one embodiment” or “an embodiment” is intended to indicate that a particular feature, structure, or characteristics described in connection with the embodiment is included in at least an embodiment of the invention. The appearances of the phrases “in one embodiment” or “an embodiment” in various places in the specification are not necessarily all referring to the same embodiment.

As used in this disclosure, except where the context requires otherwise, the term “comprise” and various of the term, such as “comprising”, “comprises”, and “comprised”, are not intended to exclude other additives, components, integers, or steps.

In the following description, specific details are given to provide a thorough understanding of the embodiments. However, it will be understood by one of ordinary skill in the art that the embodiments may be practiced without these specific details. Well-known features, elements or techniques may be shown in detail in order not to obscure the embodiments.

The system of the present invention is suitable for a financial market pattern detector and alert method, system, and device.

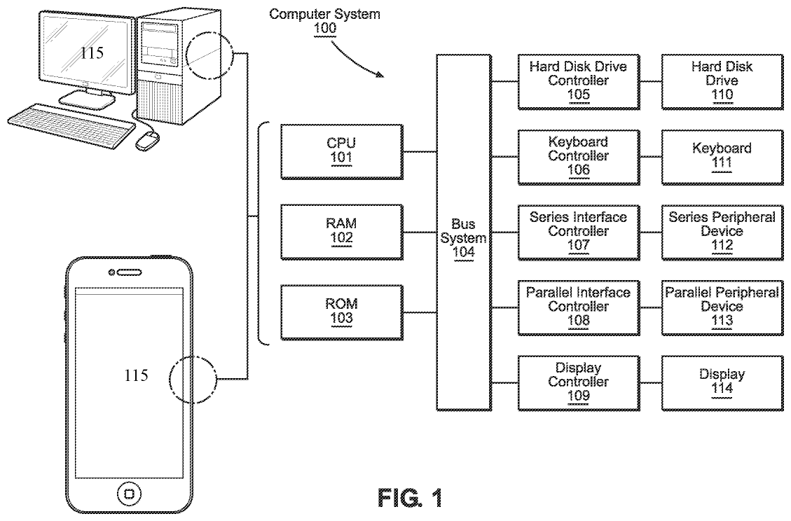

FIG. 1 shows the network connections between the devices, which are capable of implementing the present embodiments.

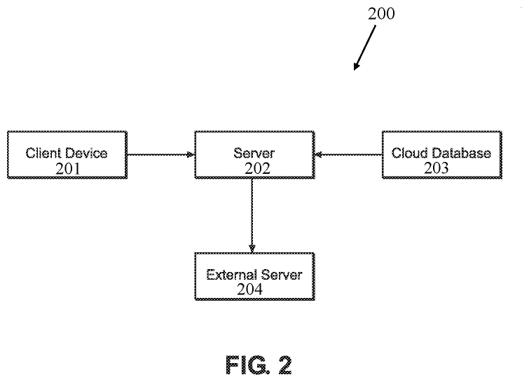

FIG. 2 is an exemplary illustrative network environment where various embodiments of the present invention are said to function.

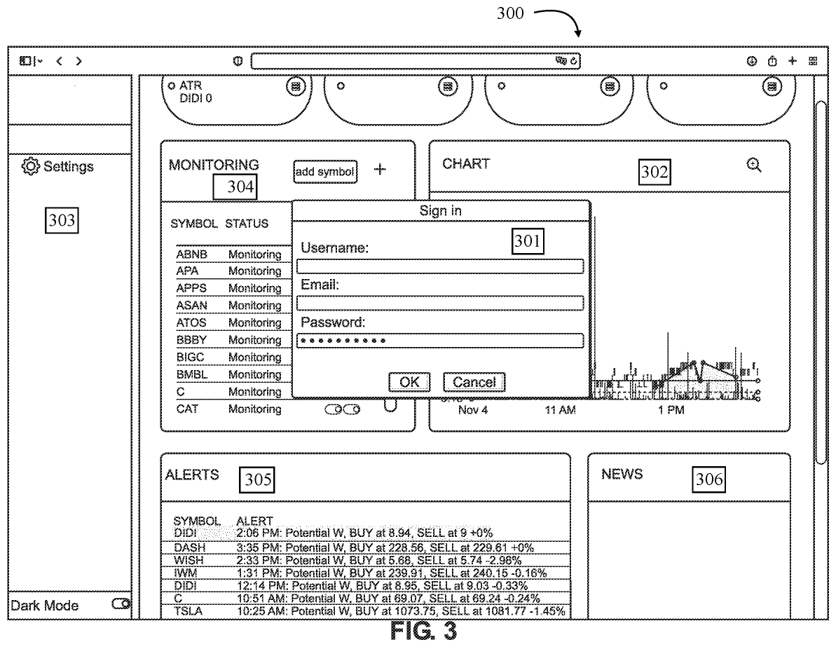

FIG. 3 is an exemplary illustrative user interface where various embodiments of the present invention are said to function.

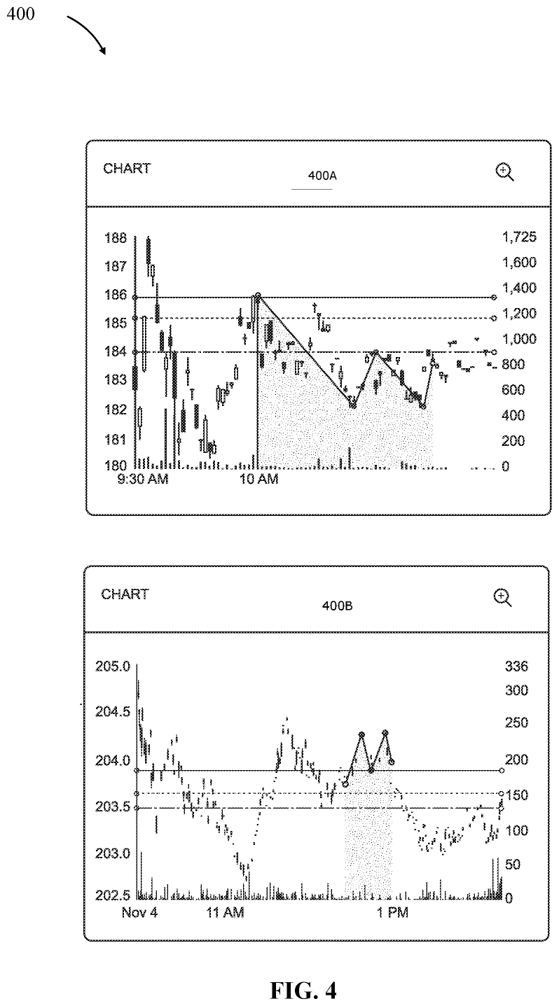

FIG. 4 is an exemplary illustrative embodiment of the chart module.

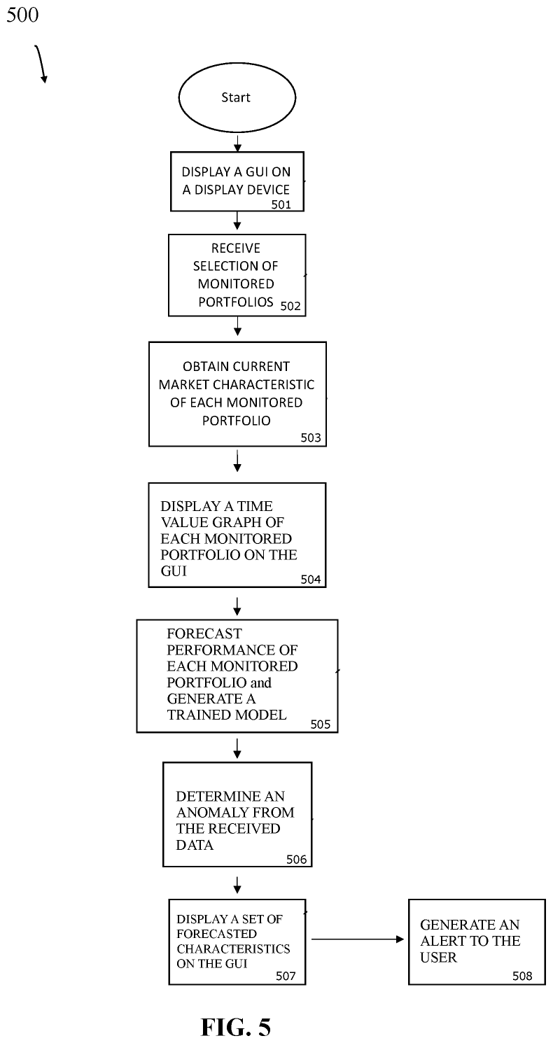

FIG. 5 shows a flow chart of an exemplary financial market alert generation consistent with disclosed embodiments.

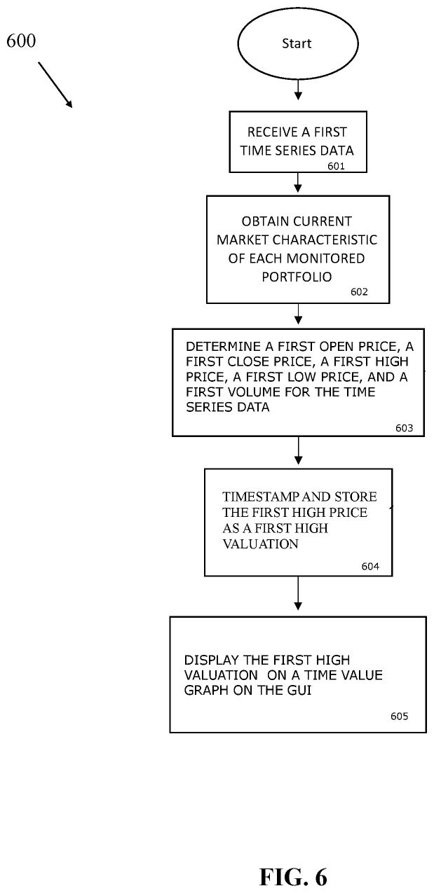

FIG. 6 shows a flow chart of an exemplary method for generating a first high valuation for a first pattern, consistent with disclosed embodiments.

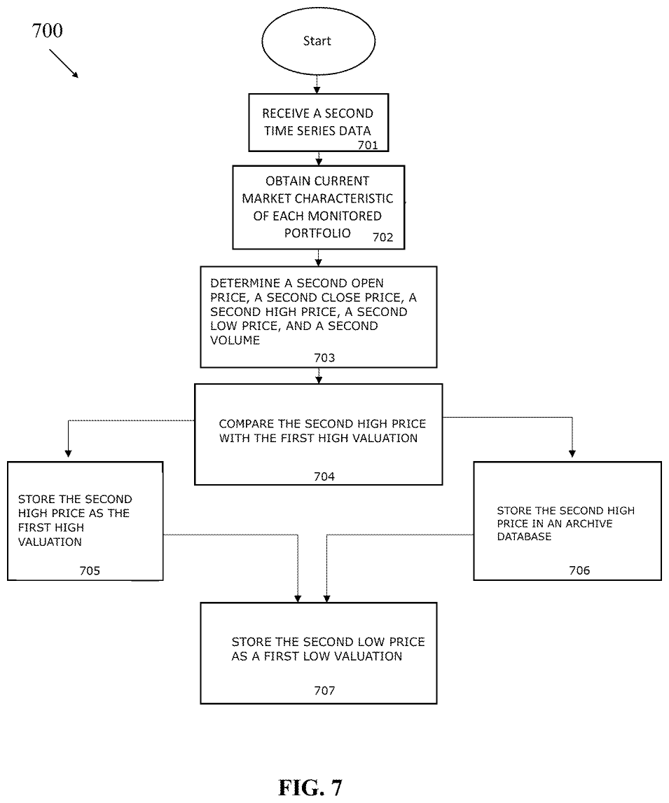

FIG. 7 shows a flow chart of an exemplary method for generating a first low valuation for a first pattern, consistent with disclosed embodiments.

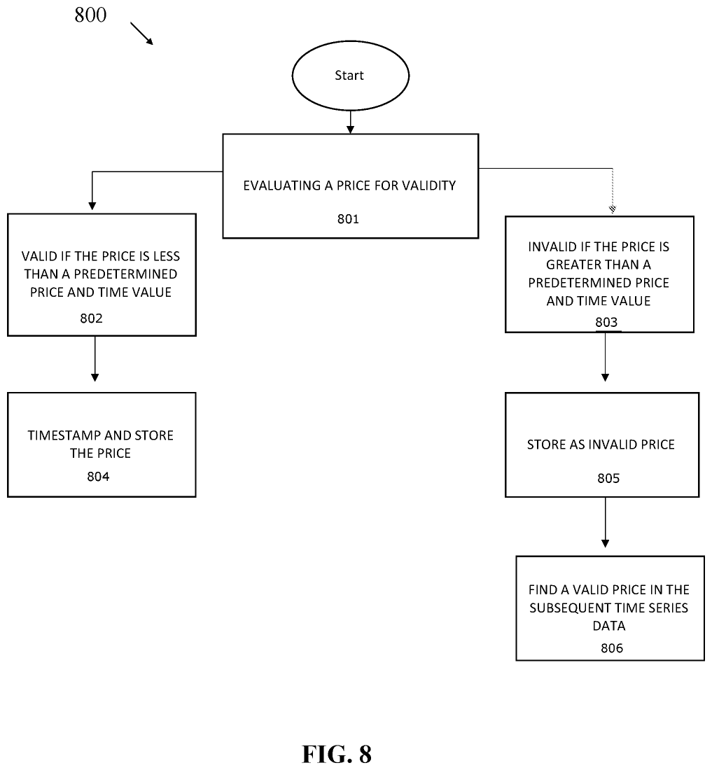

FIG. 8 shows a flow chart of an exemplary method for evaluating a price for validity for a first pattern, consistent with disclosed embodiments.

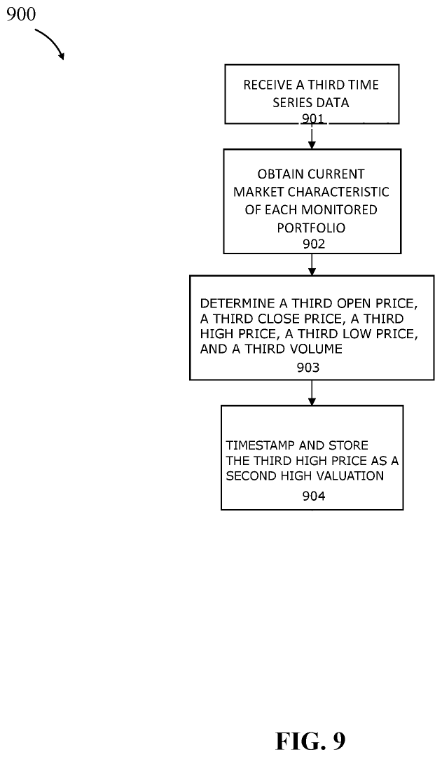

FIG. 9 shows a flow chart of an exemplary method for generating a second high valuation for a first pattern, consistent with disclosed embodiments.

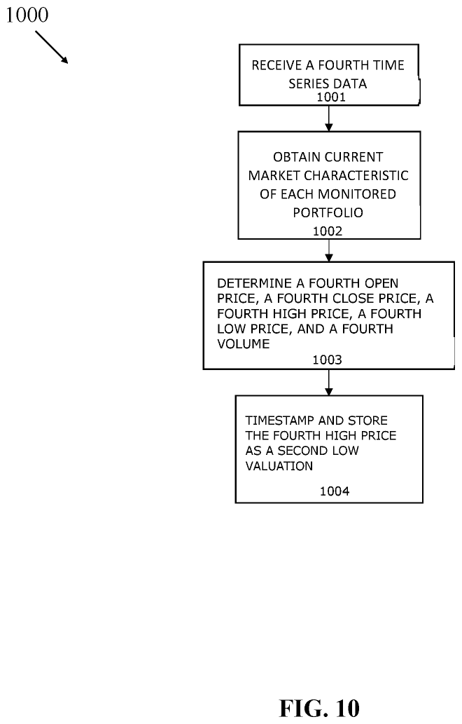

FIG. 10 shows a flow chart of an exemplary method for generating a second low valuation for a first pattern, consistent with disclosed embodiments.

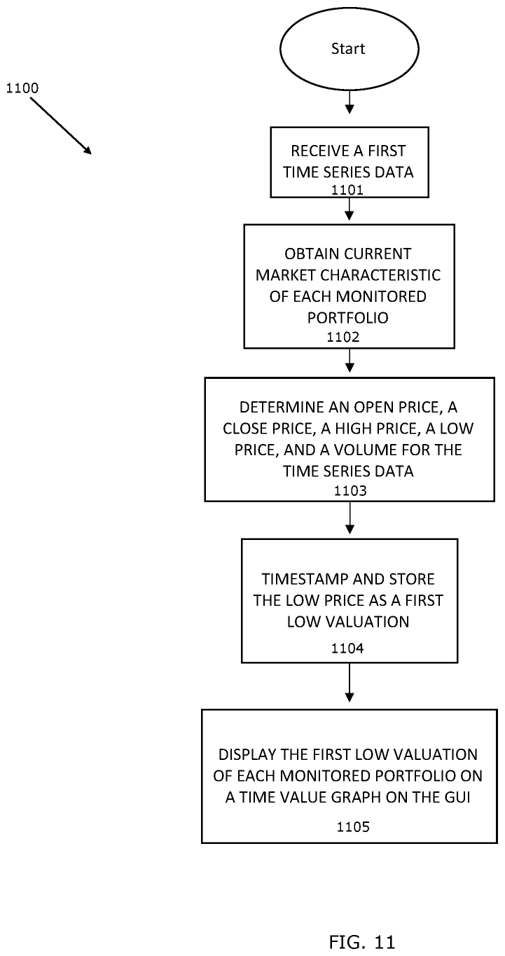

FIG. 11 shows a flow chart of an exemplary method for generating a first low valuation for a second pattern, consistent with disclosed embodiments.

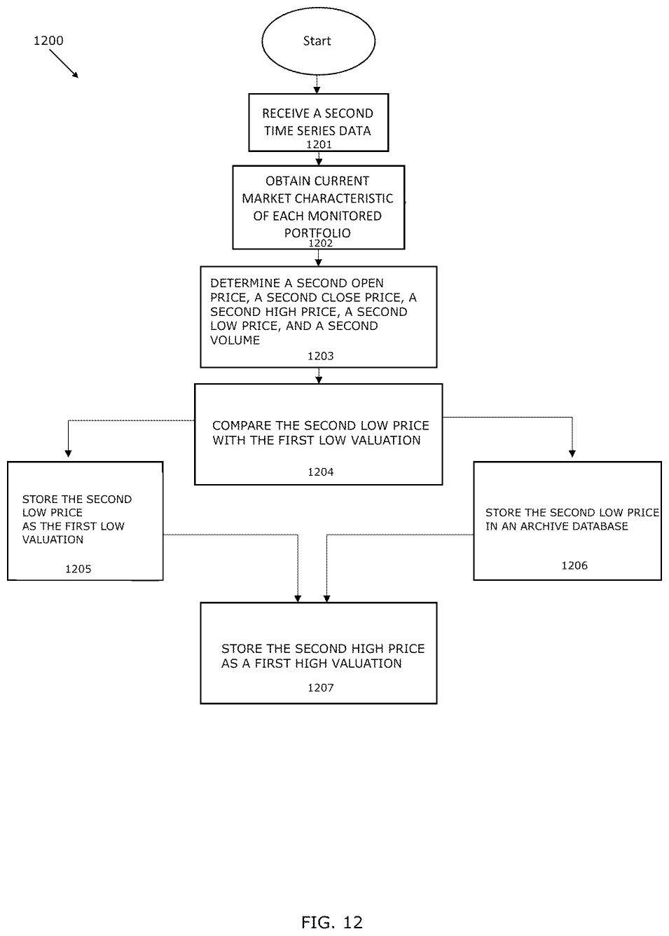

FIG. 12 shows a flow chart of an exemplary method for generating a first high valuation for a second pattern, consistent with disclosed embodiments.

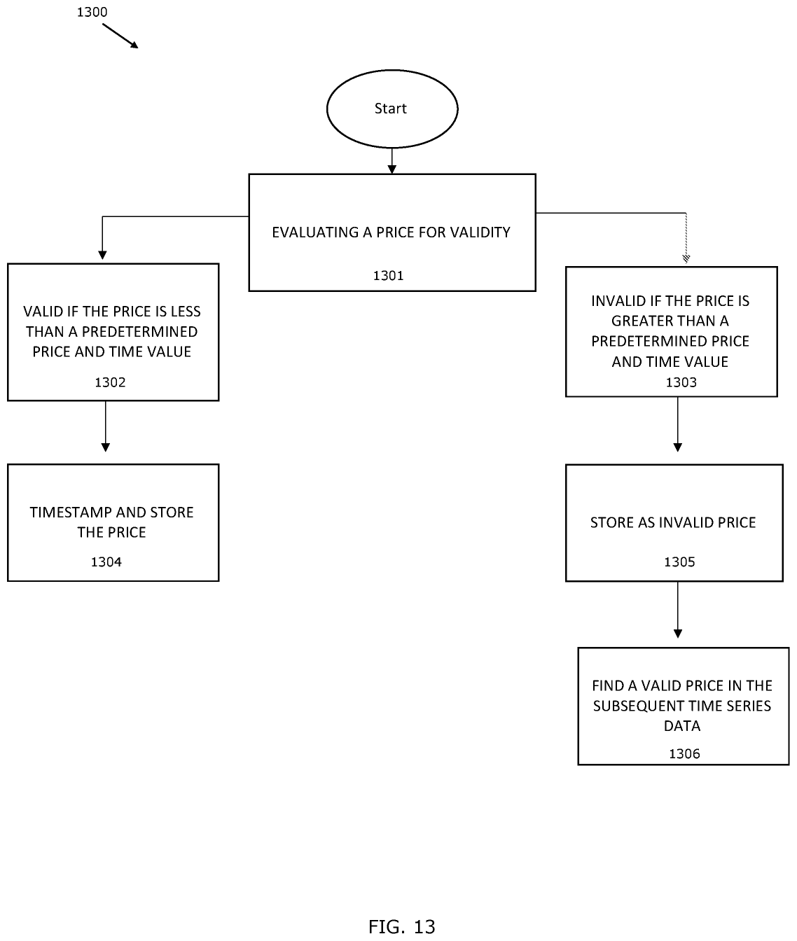

FIG. 13 shows a flow chart of an exemplary method for evaluating a price for validity for a second pattern, consistent with disclosed embodiments.

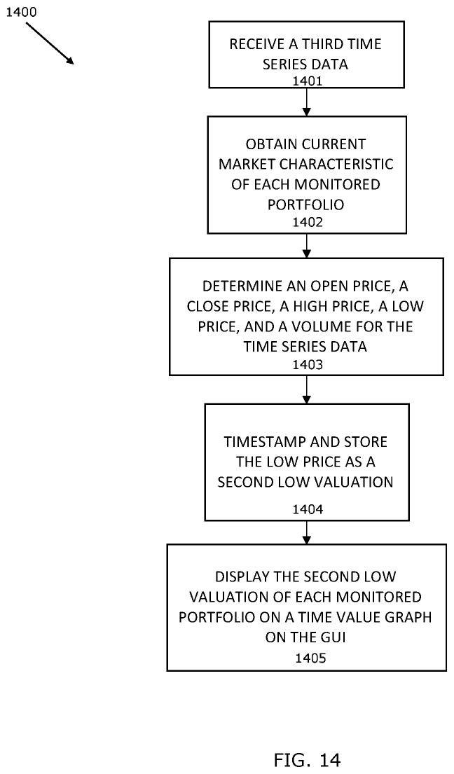

FIG. 14 shows a flow chart of an exemplary method for generating a second low valuation for a second pattern, consistent with disclosed embodiments.

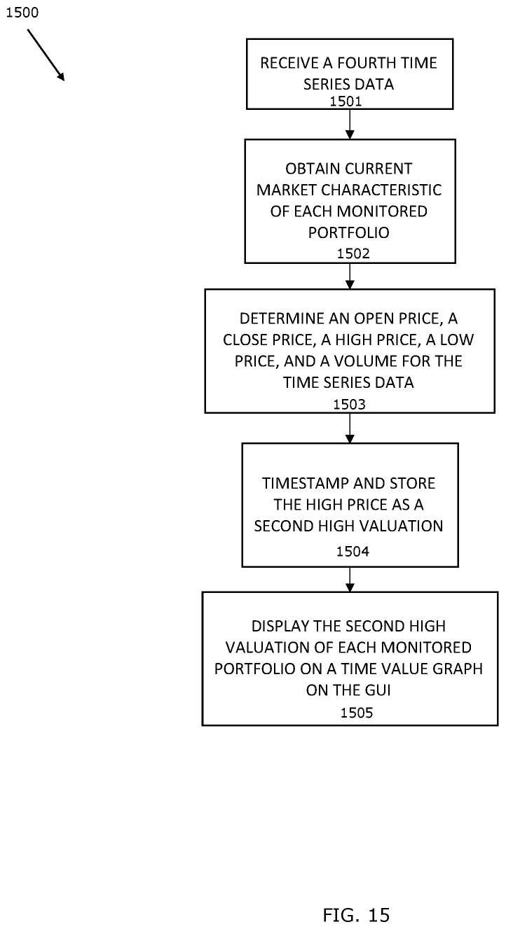

FIG. 15 shows a flow chart of an exemplary method for generating a second high valuation for a second pattern, consistent with disclosed embodiments.

Although the present invention has been described with a degree of particularity, it is understood that the present disclosure has been made by way of examples and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in the disclosure.

FIG. 1 shows the network connections between the devices in the environment, which are capable of implementing the present embodiments. Computing device 115 can be of a portable device or a non-portable device. Client device 115 may be a handheld device, a mobile device, smartphone, personal digital assistant (PDA), a personal computer, netbook, laptop, a tablet, or similar computer system devices equipped with a wireless transceiver providing the communication interface. The client device may comprise of a central processing unit 101, a random-access memory 102, a read only memory 103, at least one bus 104, a plurality of controllers 105-109, a plurality of ports, such as a USB port, a data storage devices 110, such as a hard disk drive or a flash memory, a keyboard 111, a series and parallel peripheral device 112-113, and a display 114. Client devices may comprise of an operating module working conjointly with the processor to execute a plurality of machine learning algorithms, the data and models of which are stored in memory. Client device 115 may further be of an audio interface, a video interface, a network interface, an input-output interface, and at least one display. Client device 115 may be connected to at least one Server 202 as displayed in FIG. 2. Turning attention to FIG. 2.

FIG. 2 is an exemplary illustrative network environment where various embodiments of the present invention are said to function. Client device 201 may be connected to at least one Server 202. Server 202 may be connected to at least one external server 204 and a central Database 203. Database 203 may comprise of a cloud-based server and may further include at least one archived database. Server 202 is configured to receive and transmit information between the client device 201 and Database 203. Server 202 may comprise of system to run server applications, to maintain the databases, and a network to connect devices to the internet. The network may comprise of a communication interface. The external server may be that of a financial market server.

The communication interface can be a wired or wireless interface. The communication interface can be a short-range communication interface such as WiFi, WiFi-direct, Bluetooth, ZigBee, WiMedia UWB, Infra Red, and any similar technology. The network may comprise of a local area network (LAN), a wide-area network (WAN), or the internet. The communication interface connects the client devices 201 with the server 202 and the database 203. The client device, the server, and the database having the necessary hardware and or software functionalities. The client device can utilize any traditional mobile or wireless infrastructure, based network such as CDMA. Further, the CDMA network may implement a radio technology such as Universal Terrestrial Radio Access (UTRA) and CDMA2000. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM) and General Packet Radio Service (GPRS). An OFDMA network may implement a radio technology such as Evolved UTRA (E-UTRA), Ultra Mobile Broadband (UMB), IEEE 802.11 (WiFi), IEEE 802.16 (WiMAX), IEEE 802.20, Flash-OFDM. The network allows the client device, the server, and the databases to intermittently communicate. Turning attention to FIG. 3.

FIG. 3 is an exemplary illustrative user interface where various embodiments of the present invention are said to function. The algorithm may execute as a web application or a mobile application. The mobile application may be a stand-alone or a non-stand-alone application. The invention is geared towards the financial market industry; however, the system may be applied to various related and non-related industries. Users of client device 201 may create an account by entering information, such as a name 301, an email 301, a password 301, and other similar data. A user of the device may be a day trader, third party servers and or websites that support traders, a broker, an investor, a company, and other traditional participants of the financial market. Upon entering the account, a user may have access to a plurality of modules, such as a chart module 302, a settings module 303, a monitoring module 304, an alert module 305, and a news portal 306.

Alert module 305 may allow the user to monitor a selected number of financial market data, through a set of alerts and or system notifications. The user may be notified via various methods, specifically users of client device 201 may be notified via web browser notifications, a short message service application (SMS), multimedia messaging service applications (MMS), or similar platforms. Voice notifications, sound notifications, and or in-app messaging notifications may also be implemented. The alerts may be based on the detection of at least one pattern. Time series data may be extracted in real time, by the server 202 from an external financial market server. The server may transmit financial market data to the client device 201.

The server may store and create a historical database of all of the data. The system may perform a set of mathematical computations, and through these computations, generate and store at least one trained model. By use of the trained model, the system may predict financial market behavior, as data is received continuously, and produce alerts and or notifications, indicating that a user should enter, exit, sale, or purchase an asset in the financial market. Specifically, a notification may be generated to indicate a first reversal, a second reversal, a first indicator, a second indicator, a first entry target, a second entry target, a first target exit target, and a second target exit. The system may automatically alert the user based on predetermined settings. A user may also determine the intervals for receipt of notifications. The system may further allow a user to halt notifications for any interval of time or day. Turning attention to FIG. 4.

FIG. 4 is an exemplary illustrative embodiment of the chart module 400. The application software may predict the formation of a first forecasted pattern 400A and or a second forecasted pattern 400B. Each pattern will be used by the algorithm to forecast and automatically alert the user of a plurality of market characteristics. The forecasted market characteristics may be a first reversal, a second reversal, a first indicator, a second indicator, a first entry target, a second entry target, a first exit target, and a second exit target as an alert displaying on the GUI of the user device. Turning attention to FIG. 5.

FIG. 5 shows a flow chart of an exemplary financial market alert generation consistent with disclosed embodiments. At step 501 a GUI depicting the application software is displayed on the device. At step 502 the application software receives a selection of a monitored portfolio. A user may search the application software for at least one publicly listed company selling assets, in for example, a stock exchange. At step 503 the server obtains current market characteristics of each monitored portfolio. At step 504 a time value graph is displayed on the user device. At step 505 the system may forecast the performance of each monitored portfolio. At step 506 the system determines an anomaly from the received data. At step 507 the forecasted characteristics are displayed on the GUI. At step 508 at least one alert is generated on the GUI. The system will generate and display a time-value graphical representation for the data of each selected publicly listed company, in real time, along with the entry and exits points, and other predictions. The algorithm can perform its analysis and generate a graph in at most fifteen milliseconds.

The algorithm continuously searches for a plurality of patterns by evaluating the received time series data. For example, the algorithm may continuously search for an M and W pattern. These patterns may be detected either alone or simultaneously. A user may select to be alerted of either one or all of the patterns as they occur, or the system may automatically alert the user. FIG. 6-FIG. 10 are exemplary methods for detecting a W pattern.

W Pattern

FIG. 6 shows a flow chart of an exemplary method for generating a first high valuation for a first pattern, consistent with disclosed embodiments. The system is set to detect a first high valuation, a first low valuation, a second high valuation, and a second low valuation, from a continuous set of time series data depicting current market characteristics. The server executes the algorithm to perform all of these steps. The first high valuation may be greater in value and less in time than the first low valuation (see FIG. 400A). The first low valuation may be less in value and less in time than the second high valuation (see FIG. 400A). The second high valuation may be greater in value and less in time than the second low valuation (see FIG. 400A). At step 601 the system receives a first time series data. At step 602 the system obtains market characteristics of each monitored portfolio. At step 603 the system determines a first open price, a first close price, a first high price, a first low price, and a first volume. At step 604 the system stores and timestamps the first high price as a first high valuation for each monitored market portfolio. Turning attention to FIG. 7.

FIG. 7 shows a flow chart of an exemplary method for generating a first low valuation for a first pattern, consistent with disclosed embodiments. At step 701 server 202 receives a second time series dataset from the external server or database 203. At step 702 the current market characteristics of each monitored portfolio is received. At step 703 a second open price, a second close price, a second high price, a second low price, and a second volume are determined. At step 704 the server executes the algorithm to compare the second high price with the first high valuation. The algorithm may store the second high price as the first high valuation, thus replacing the first high price, if the second high price is numerically greater than the first high price. At step 705 a new timestamp may be generated if the first high valuation is replaced. At step 706 if the first high valuation is not replaced, the system archives the second high price. At step 707 the system stores the second low price as a first low valuation and timestamps the data. The first low valuation may be evaluated for validity. Turning attention to FIG. 8.

FIG. 8 shows a flow chart of an exemplary method for evaluating a price for validity for a first pattern, consistent with disclosed embodiments. At step 801 the system will evaluate the first low valuation (see FIG. 400A). The first low valuation will be determined valid if the first low valuation is less than a predetermined value and distance in time. As to the predetermined value, the difference in value between the first high valuation and the first low valuation must be at least twenty-five percent of the average true range of the financial market, i.e. (high valuation−low valuation)=0.25 (average true range). The average true range of the financial market may be transmitted to the server by the external database. The average true range may show how much an asset moves, on average, during a given time frame. The time frame may be fourteen days. As to the predetermined distance in time, the distance in time between the first high valuation and the first low valuation must be within the interval of five to thirty minutes. If the first low valuation is determined to be valid, the first low valuation is stored and timestamped and added to the graphical representation displayed to the user of the client device 201, as shown in step 803. If the first low valuation is determined to be invalid, step 805, first low valuation is stored as an invalid variable and timestamped as shown in step 806. In the event of an invalid variable, as shown in step 807, the server searches for a valid first low valuation. Turning attention to FIG. 9.

FIG. 9 shows a flow chart of an exemplary method for generating a second high valuation for a first pattern, consistent with disclosed embodiments. At step 901 the server 202 receives a third time series data from the external server or database 203. At step 902 the current market characteristics of each monitored portfolio is received. At step 903 a third open price, a third close price, a third high price, a third low price, and a third volume for the second set of data is determined. At step 904 the high price is timestamped and stored as a second high valuation. The second high valuation may be evaluated for validity.

The system will evaluate the second high valuation for validity. The second high valuation will be deemed valid if the price is within a predetermined value and distance in time. As to the predetermined value, the difference in value between the second high valuation and the first low valuation is computed to find a first value. The difference between the first high valuation and the first low valuation is computed to find a second value. The ratio between the first value and the second value is calculated to find a third value. To be valid, the third value must be equal to or greater than 0.382 and no less than 1. Thus, the following conditions apply:

$$\frac{Second High Valuation - First Low Valuation}{First High Valuation - First Low Valuation} \geq .382 \&$$

$$\frac{Second High Valuation - First Low Valuation}{First High Valuation - First Low Valuation} < 1$$

The algorithm also computes the distance in time. The distance in time between the first low valuation and the second high valuation is computed to find a first distance in time. The first distance in time must between the interval of five to thirty minutes to be valid. If the second high valuation is determined to be valid, the second high price is stored and timestamped and added to the displayed graphical representation. Turning attention to FIG. 10.

FIG. 10 shows a flow chart of an exemplary method for generating a second low valuation for a first pattern, consistent with disclosed embodiments. At step 1001 server 202 receives a fourth time series data from the external server or database 203. At step 1002, the current market characteristics of each monitored portfolio is received. At step 1003, a fourth open price, a fourth close price, a fourth high price, a fourth low price, and a fourth volume is determined. At step 1004, the server timestamps and stores the fourth low price as a second low valuation. The second low valuation may be evaluated for validity.

The system will evaluate the second low valuation for validity. The second low valuation will be deemed valid if the valuation is within a predetermined value and distance in time. As to the predetermined value, the difference between the second high valuation and the first low valuation is computed to find a fourth value. The difference between the second high valuation and the second low valuation is computed to find a fifth value. The ratio between the fourth value and the fifth value is computed to find a sixth value. To be valid, the sixth value must be equal to or greater than 0.618 and less than 1.618. Thus, the following conditions apply:

$$\frac{Second High Valuation - First Low Valuation}{Second High Valuation - Second Low Valuation} \geq .618 \&$$

$$\frac{Second High Valuation - First Low Valuation}{Second High Valuation - Second Low Valuation} < 1.618$$

The algorithm also computes the distance in time. The distance in time between the first low valuation and the second high valuation is determined to find a third distance in time. The distance in time between the second high valuation and the second low valuation is determined to find a fourth distance in time. The ratio between the third distance in time and the fourth distance in time may be computed to find a fifth distance in time. To be valid, the fifth distance in time, must be greater than or equal to 0.382 and no more than 1.382. If the second low valuation is determined to be valid, the second low valuation is stored and timestamped. If the second low valuation is determined to be invalid, the second low valuation is stored as an invalid variable and timestamped and the system continues the search for a valid valuation. FIG. 11-FIG. 15 are exemplary methods for detecting an M pattern.

M Pattern

FIG. 11 shows a flow chart of an exemplary method for generating a first low valuation for a second pattern, consistent with disclosed embodiments. The algorithm is set to detect a first high valuation, a first low valuation, a second high valuation, and a second low valuation, from a continuous set of time series data depicting current market characteristics. The first low valuation may be less in value and less in time than the first high valuation (see FIG. 400B). The first high valuation may be greater in value and less in time than the second low valuation (see FIG. 400B). The second low valuation may be less in value and less in time than the second high valuation (see FIG. 400B). At step 1101 the system receives a first time series data. At step 1102 the system obtains market characteristics of each monitored portfolio. At step 1103 the system determines a first open price, a first close price, a first high price, a first low price, and a first volume. At step 1104 the system stores and timestamps the first low price as a first low valuation for each monitored market portfolio. Turning attention to FIG. 12.

FIG. 12 shows a flow chart of an exemplary method for generating a first high valuation for a second pattern, consistent with disclosed embodiments. At step 1201 server 202 receives a second time series dataset from the external server or database 203. At step 1202 the current market characteristics of each monitored portfolio is received. At step 1203 a second open price, a second close price, a second high price, a second low price, and a second volume are determined. At step 1204 the server executes the algorithm to compare the second low price with the first low valuation. The algorithm may store the second low price as the first low valuation, thus replacing the first low price, if the second low price is numerically lower than the first low price. At step 1205 a new timestamp may be generated if the first low valuation is replaced. At step 1206 if the first low valuation is not replaced, the system archives the second low price. At step 1207 the system stores the second high price as a first high valuation and timestamps the data. The first high valuation may be evaluated for validity. Turning attention to FIG. 13.

FIG. 13 shows a flow chart of an exemplary method for evaluating a price for validity for a second pattern, consistent with disclosed embodiments. At step 1301 the system will evaluate the first high valuation (see FIG. 400B). The first high valuation will be determined valid if the first high valuation is less than a predetermined value and distance in time 1302. As to the predetermined value, the difference in value between the first high valuation and the first low valuation must be at least twenty-five percent of the average true range of the financial market, i.e. (high valuation−low valuation)=0.25 (average true range). The average true range of the financial market may be transmitted to the server by the external database. The average true range may show how much an asset moves, on average, during a given time frame. The time frame may be fourteen days. As to the predetermined distance in time, the distance in time between the first high valuation and the first low valuation must be within the interval of five to thirty minutes. If the first high valuation is determined to be valid, the first high valuation is stored and timestamped and added to the graphical representation displayed to the user of the client device 201 as shown in step 1304. If the first high valuation is determined to be invalid, step 1303, first high valuation is stored as an invalid variable, 1305, and timestamped. In the event of an invalid variable, as shown in step 1306, the server searches for a valid first high valuation. Turning attention to FIG. 14.

FIG. 14 shows a flow chart of an exemplary method for generating a second low valuation for a second pattern, consistent with disclosed embodiments. At step 1401 the server 202 receives a third time series data from the external server or database 203. At step 1402 the current market characteristics of each monitored portfolio is received. At step 1403 a third open price, a third close price, a third high price, a third low price, and a third volume for the second set of data is determined. At step 1404 the low price is timestamped and stored as a second low valuation and displayed on the GUI 1405. The second low valuation may be evaluated for validity.

The system will evaluate the second low valuation for validity. The second low valuation will be deemed valid if the price is within a predetermined value and distance in time. As to the predetermined value, the difference in value between the second low valuation and the first high valuation is computed to find a first value. The difference between the first high valuation and the first low valuation is computed to find a second value. The ratio between the first value and the second value is calculated to find a third value. To be valid, the third value must be equal to or greater than 0.382 and no less than 1. Thus, the following conditions apply:

$$\frac{First High Valuation - Second Low Valuation}{First High Valuation - First Low Valuation} \geq .382 \&$$

$$\frac{First High Valuation - Second Low Valuation}{First High Valuation - First Low Valuation} < 1$$

The algorithm also computes the distance in time. The distance in time between the first high valuation and the second low valuation is computed to find a first distance in time. The first distance in time must be between the interval of five to thirty minutes to be valid. If the second low valuation is determined to be valid, the second low price is stored and timestamped and added to the displayed graphical representation. Turning attention to FIG. 15.

FIG. 15 shows a flow chart of an exemplary method for generating a second high valuation for a second pattern, consistent with disclosed embodiments. At step 1501 server 202 receives a fourth time series data from the external server or database 203. At step 1502, the current market characteristics of each monitored portfolio is received. At step 1503, a fourth open price, a fourth close price, a fourth high price, a fourth low price, and a fourth volume is determined. At step 1504, the server timestamps and stores the fourth high price as a second high valuation. The second high valuation is displayed on the GUI 1505. The second high valuation may be evaluated for validity.

The system will evaluate the second high valuation for validity. The second high valuation will be deemed valid if the valuation is within a predetermined value and distance in time. As to the predetermined value, the difference between the second high valuation and the second low valuation is computed to find a fourth value. The difference between the first high valuation and the second low valuation is computed to find a fifth value. The ratio between the fourth value and the fifth value is computed to find a sixth value. To be valid, the sixth value must be equal to or greater than 0.618 and less than 1.618. Thus, the following conditions apply:

$$\frac{Second High Valuation - Second Low Valuation}{First High Valuation - Second Low Valuation} \geq .618 \&$$

$$\frac{Second High Valuation - Second Low Valuation}{First High Valuation - Second Low Valuation} < 1.618$$

The algorithm also computes the distance in time. The distance in time between the first high valuation and the second low valuation is determined to find a third distance in time. The distance in time between the second low valuation and the second high valuation is determined to find a fourth distance in time. The ratio between the third distance in time and the fourth distance in time may be computed to find a fifth distance in time. To be valid, the fifth distance in time, must be greater than or equal to 0.382 and no more than 1.382. If the second high valuation is determined to be valid, the second high valuation is stored and timestamped. If the second high valuation is determined to be invalid, the second high valuation is stored as an invalid variable and timestamped and the system continues the search for a valid valuation.

Anomaly Detection

As time series data is received and the valuations are found, the algorithm evaluates the data for anomalies (as shown in FIG. 1) for both the W pattern and the M pattern. Traditional methods for anomaly detection proved to be incompatible with the present invention. Thus, a unique system was created. To detect an anomaly, the algorithm performs two steps. First, the server performs a scoring algorithm.

As a first step to anomaly detection, the server computes a scoring algorithm. The algorithm computes a slope for a first line, a second line, and a third line created by the valuations. To calculate the slope, the following is computed:

$$\frac{High Valuation - Low Valuation}{Total Points on The Line} = Slope$$

With the slope, the expected value of the second price on the line is computed:

High Valuation−Slope=Expected Value

The expected value may not equate the actual value. In this instance, the actual deviation between the expected value and the actual value is computed:

Actual Value−Expected Value=Actual Deviation

Actual Deviation/Slope 1<700%=Low Deviation

Actual Deviation/Slope 1>700%=High Deviation

High Deviation/Low Deviation<0.5=Anomaly

Or

Low Deviation/High Deviation<0.5=Anomaly

A ratio greater than or equal to 0.5 indicates that the points describe a good line as they are equal on both sides, thus the line may receive a good score. A ratio less than 0.5 indicates that too many points are either above or below the line, thus the line may receive a bad score, and the pattern may be aborted. Next, the server executes the algorithm to calculate a midpoint of a triangular pattern formed by at least three of the valuations.

As a second step to anomaly detection, the algorithm calculates a midpoint of a triangular pattern created by the valuations. The first high valuation, the first low valuation, the second high valuation, and the second low valuation may together form at least two triangles, with at most three points. The value of the midpoint between the top and the bottom of the triangle is computed. The system determines how many data points lie 0.2% percent above or below the midpoint. Two midpoints are calculated using both triangles, a first midpoint is found for triangle one and a second midpoint is found for triangle two. For each triangle, the total number of the points above the line is added to the total number of the points below the line and the result is divided by the number of points forming the triangle. The two midpoints are summed to determine an anomaly. An anomaly is detected for a result greater than 1.3. Thus, the following computations apply:

$$\frac{\begin{matrix}Total Points Above The Midpoint + \\ Total Points Below The Midpoint\end{matrix}}{Total Points On The Triangle} = MidPoint 1$$

$$\frac{\begin{matrix}Total Points Above The Midpoint + \\ Total Points Below The Midpoint\end{matrix}}{Total Points On The Triangle} = MidPoint 2$$

$$MidPoint 1 + MidPoint 2 > 1.3 = Anomaly$$

Upon the detection of an anomaly, the system may abandon the pattern. If an anomaly is not detected the system may alert the user of a first forecasted pattern (as shown in FIG. 4, 400A) and a second forecasted pattern (as shown in FIG. 4, 400B) and of various market characteristics.

A machine learner may be trained for forecasting a plurality of market characteristics using the using the techniques disclosed herein. The machine learning algorithm may iteratively execute to determine a plurality of market characteristics, and to generate a first pattern (as shown in FIG. 4, 400A) and a second pattern (as shown in FIG. 4, 400B). The patterns may indicate points in which a user should exit, sell, or hold assets in a financial market. The market characteristics may comprise of a first reversal, a second reversal, a first indicator, a second indicator, a first entry target, a second entry target, a first exit target and a second exit target.

A first reversal may be detected at a 0.236 ratio level and a second reversal may be detected at 0.382 ratio level. A first reversal may be defined as the point at which the system determines that a pattern has reversed after a valid second lowest point has been found (W pattern) or a valid second high point has been found (M pattern). A second reversal may be defined as a subsequent indicator of a pattern reversal after a valid second lowest point has been found (W pattern) or a valid second high point has been found (M pattern).

A first indicator may be detected at 0.618 ratio level and a second indicator may be detected at 0.786 ratio level. A first indicator may be defined as a point at which the system determines the pattern will continue its current trend. The second indicator may be defined as a subsequent indicator that a pattern will continue its current trend.

A first entry target may be detected at a ratio level of 1 and a second entry target may be detected at 1.13 ratio level. A first entry target may be defined as the first point at which the application software may automatically alert a user of an entrance point into at least one financial market. A second entry target may be defined as the second point at which the application software may automatically alert a user of a subsequent entry point into at least one financial market. The second entry target generates less risk and less financial gain for the user.

A first exit target may be detected at 1.618 ratio level and a second exit point may be detected at a ratio level of 2. A first exit target may be defined as the point at which the application software may automatically alert a user to exit or sell assets in at least one financial market. The second exit target may be defined a subsequent point where the application software may automatically alert a user to exit or sell assets in at least one financial market. The second exit target generates high risk for the user.

A user may be alerted of a buy target, an exit target, and a high exit target based on the forecasted market characteristics. A user of the device may elect to be alerted of a buy target at a second reversal, a first indicator, a second indicator, a first entry, and a second entry. A user of the device may elect to be alerted of an exit target at a second indicator, a first entry, a second entry, a first exit target, and second exit target. A user may elect to be alerted of a high exit target at a first entry, a second entry, a first exit target, and second exit target. The system may also automatically generate the alerts.

All features disclosed in the specification, including the claims, abstracts, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or some similar purpose, unless expressly stated otherwise. Thus, unless expressly stated otherwise, each feature disclosed is one example only of a generic series of equivalent or similar features.

While the present invention generally described herein has been disclosed in connection with a number of embodiments shown and described in detail, various modifications should be readily apparent to those of skill in the art.

What is claimed is:

1. A machine learning method for detecting a financial market pattern in operation of a data analysis device, the method comprising an algorithm executing on at least one processor for:
monitoring at least one financial market portfolio;
receiving, in real time, a continuous set of time series readings of the financial market portfolio, and maintaining a history of past real-time readings;
determining a first high valuation and storing the first high valuation;
determining a first low valuation and storing the first low valuation;
determining a second high valuation and storing the second high valuation;
determining, a second low valuation and storing the second low valuation;
computing a first and a second deviation between present real time readings and past real time readings;
declaring an anomaly when said deviation exceeds a predetermined threshold;
forecasting a set of market characteristics;
generating a first financial model;
generating a second financial model;
displaying the first financial model and the second financial model on a GUI of a user device; and
generating at least one alert on the GUI of the user device.

2. The machine learning method for detecting a financial market pattern in operation of a data analysis device of claim 1, wherein the first high valuation is less in time and greater in value than the first low valuation, the first low valuation is less in time and less in value than the second high valuation, and the second high valuation is less in time and greater in value than the second low valuation.

3. The machine learning method for detecting a financial market pattern in operation of a data analysis device of claim 1, wherein the first low valuation is less in time and less in value than the first high valuation, the first high valuation is less in time and greater in value than the second low valuation, and the second low valuation is less in time and less in value than the second high valuation.

4. The machine learning method for detecting a financial market pattern in operation of a data analysis device of claim 1, wherein the first financial model and the second financial model is generated using a machine learning algorithm trained using the first high valuation, the second high valuation, the first low valuation, the second low valuation, and the forecasted market characteristics.

5. The machine learning method for detecting a financial market pattern in operation of a data analysis device of claim 4, wherein the machine learning algorithm iteratively executes on the processor to identify a first reversal, a second reversal, a first indicator, a second indicator, a first entry target, a second entry target, a first exit target, a second exit target, a first pattern, and a second pattern.

6. The machine learning method for detecting a financial market pattern in operation of a data analysis device of claim 6, wherein the first reversal is identified at a first ratio level and the second reversal is identified at a second ratio level.

7. The machine learning method for detecting a financial market pattern in operation of a data analysis device of claim 6, wherein a first indicator is identified at a third ratio level and the second indicator is identified at a fourth ratio level.

8. The machine learning method for detecting a financial market pattern in operation of a data analysis device of claim 6, wherein a first entry target is identified at a fifth ratio level and a second entry target is identified at a sixth ratio level.

9. The machine learning method for detecting a financial market pattern in operation of a data analysis device of claim 6, wherein the first exit target is identified at a seventh ratio level; and the second exit target is identified at an eight-ratio level.

10. The machine learning method for detecting a financial market pattern in operation of a data analysis device of claim 1, wherein the first deviation is a deviation greater than 0.5.

11. The machine learning method for detecting a financial market pattern in operation of a data analysis device of claim 1, wherein the second deviation is a deviation greater than 1.3.

12. The machine learning method for detecting a financial market pattern in operation of a data analysis device of claim 10, wherein the deviation is computed using a scoring algorithm.

13. The machine learning method for detecting a financial market pattern in operation of a data analysis device of claim 11, wherein the deviation is computed using a midpoint algorithm.

14. A machine learning device for detecting a financial market pattern in operation of a data analysis device, the device comprising an algorithm executing on at least one processor for:
monitoring at least one financial market portfolio;
receiving, in real time, a continuous set of time series readings of the financial market portfolio, and maintaining a history of past real-time readings;
determining a first high valuation and storing the first high valuation;
determining a first low valuation and storing the first low valuation;
determining a second high valuation and storing the second high valuation;
determining, a second low valuation and storing the second low valuation;
computing a first and a second deviation between present real time readings and past real time readings;
declaring an anomaly when said deviation exceeds a predetermined threshold;
forecasting a set of market characteristics;
generating a first financial model;
generating a second financial model;
displaying the first financial model and the second financial model on a GUI of a user device; and
generating at least one alert on the GUI of the user device.

15. The machine learning device for detecting a financial market pattern in operation of a data analysis device of claim 14, wherein the first high valuation is less in time and greater in value than the first low valuation, the first low valuation is less in time and less in value than the second high valuation, and the second high valuation is less in time and greater in value than the second low valuation.

16. The machine learning device for detecting a financial market pattern in operation of a data analysis device of claim 14, wherein the first low valuation is less in time and less in value than the first high valuation, the first high valuation is less in time and greater in value than the second low valuation, and the second low valuation is less in time and less in value than the second high valuation.

17. The machine learning device for detecting a financial market pattern in operation of a data analysis device of claim 14, wherein the first financial model and the second financial model is generated using a machine learning algorithm trained using the first high valuation, the second high valuation, the first low valuation, and the second low valuation.

18. The machine learning method for detecting a financial market pattern in operation of a data analysis device of claim 14, wherein the machine learning algorithm iteratively executes on the processor to identify a first reversal, a second reversal, a first indicator, a second indicator, a first entry target, a second entry target, a first exit target, a second exit target, a first pattern, and a second pattern.

19. A machine learning system for detecting a financial market pattern in operation of a data analysis device, the system comprising an algorithm executing on at least one processor for:
monitoring at least one financial market portfolio;
receiving, in real time, a continuous set of time series readings of the financial market portfolio, and maintaining a history of past real-time readings;
determining a first high valuation and storing the first high valuation;
determining a first low valuation and storing the first low valuation;
determining a second high valuation and storing the second high valuation;
determining, a second low valuation and storing the second low valuation;
computing a first and a second deviation between present real time readings and past real time readings;
declaring an anomaly when said deviation exceeds a predetermined threshold;
forecasting a set of market characteristics;
generating a first financial model;
generating a second financial model;
displaying the first financial model and the second financial model on a GUI of a user device; and
generating at least one alert on the GUI of the user device.

20. The machine learning system for detecting a financial market pattern in operation of a data analysis device of claim 19, wherein the first high valuation is less in time and greater in value than the first low valuation, the first low valuation is less in time and less in value than the second high valuation, and the second high valuation is less in time and greater in value than the second low valuation; wherein the first financial model and the second financial model is generated using a machine learning algorithm trained using the first high valuation, the second high valuation, the first low valuation, and the second low valuation.
